(19) United States
(12) Patent Application Publication
(10) Pub. No.: US 2012/0307124 A1
(43) Pub. Date: Dec. 6, 2012

(54) ELECTRONIC DEVICE

(75) Inventor: Jun SAIKI, Osaka (JP)

(73) Assignee: Panasonic Corporation, Osaka (JP)

(21) Appl. No.: 13/339,334

(22) Filed: Dec. 28, 2011

(30) Foreign Application Priority Data
Jun. 3, 2011 (JP) 2011-124711

(51) Int. Cl. H04N 5/225

(52) U.S. Cl. 348/333.01; 348/E05.024

(57) ABSTRACT

An electronic device includes a display unit, a substrate unit, a support member, and a cover member. The substrate unit is disposed opposite the display unit and is provided with a protruding portion that extends toward the display unit. The support member is configured to support the display unit between the display unit and the substrate unit and has an avoidance portion for avoiding contact with the protruding portion. The cover member covers the protruding portion and is configured to engage the avoidance portion between the display unit and the substrate unit.

### CROSS-REFERENCE TO RELATED APPLICATIONS

This application claims priority to Japanese Patent Application No. 2011-124711, filed on Jun. 3, 2011. The entire disclosure of Japanese Patent Application No. 2011-124711 is hereby incorporated herein by reference.

### BACKGROUND

1. Technical Field

The technology disclosed herein relates to an electronic device.

2. Background Information

A digital camera is disclosed as an electronic device in Japanese Laid-Open Patent Application 2011-33988. This digital camera includes a display unit that displays images, a chassis member that supports the display unit, and a housing member. The housing member has a contact portion that supports the portion of the display unit that the chassis member cannot support. The digital camera in Japanese Laid-Open Patent Application 2011-33988 is constituted so that even if the display unit is made larger, there will be adequate strength without having the main body of the device become larger.

With a conventional electronic device, the display unit is supported by the chassis member at one face side of the chassis member. With an electronic device such as this, depending on the shape of the member disposed on the other face side of the chassis member, it may be necessary to provide a specific spacing between this member and the chassis member in order to avoid interference between this member and the chassis member. For instance, if a substrate or the like is disposed on the other face side of the chassis member, a space for avoiding contact must be provided between the chassis member and the protrusion on the substrate. Specifically, this space is essential to the device main body, so the device main body was inevitably larger in the portion corresponding to this space.

### SUMMARY

The present technology was conceived in light of the above problem, and it is one object of the present technology to provide an electronic device in which interference between parts is avoided and the main body of the device can be made thinner.

The electronic device disclosed herein includes a display unit, a substrate unit, a support member, and a cover member. The substrate unit is disposed opposite the display unit and is provided with a protruding portion that extends toward the display unit. The support member is configured to support the display unit between the display unit and the substrate unit and has an avoidance portion for avoiding contact with the protruding portion. The cover member covers the protruding portion and is configured to engage the avoidance portion between the display unit and the substrate unit.

These and other features, aspects and advantages of the present invention will become apparent to those skilled in the art from the following detailed description, which, taken in conjunction with the annexed drawings, discloses a preferred and example embodiments of the present invention.

### BRIEF DESCRIPTION OF THE DRAWINGS

Referring now to the attached drawings, which form a part of this original disclosure:

FIG. 1 is an external oblique view of the digital camera according to one embodiment of the present technology as seen from the front;

FIG. 2 is an external oblique view of the digital camera according to one embodiment of the present technology as seen from the rear;

FIG. 3 is an exploded oblique view of the digital camera according to one embodiment of the present technology as seen from the rear;

FIG. 4 is an exploded oblique view illustrating the mounting position of a battery terminal in the digital camera according to one embodiment of the present technology;

FIG. 5 is an exploded oblique view illustrating the mounting position of a cover member in the digital camera according to one embodiment of the present technology;

FIG. 6 is a partial cross section of the upper part of the digital camera according to one embodiment of the present technology;

FIG. 7 is an oblique view of the cover member of the digital camera according to one embodiment of the present technology as seen from above; and

FIG. 8 is an oblique view of the cover member of the digital camera according to one embodiment of the present technology as seen from below.

### DETAILED DESCRIPTION OF EMBODIMENTS

Selected embodiments of the present technology will now be explained with reference to the drawings. It will be apparent to those skilled in the art from this disclosure that the following descriptions of the embodiments of the present technology are provided for illustration only and not for the purpose of limiting the technology as defined by the appended claims and their equivalents.

### First Embodiment

An embodiment of the present technology will now be described through reference to the drawings. The drawings mentioned herein are typical examples, but the proportions and so forth of the dimensions may not be the same as in reality. Therefore, specific dimensions and so forth should be judged by referring to the following description. Also, there may of course be portions between the drawings that have mutually different dimensional relations or proportions.

1. External Appearance

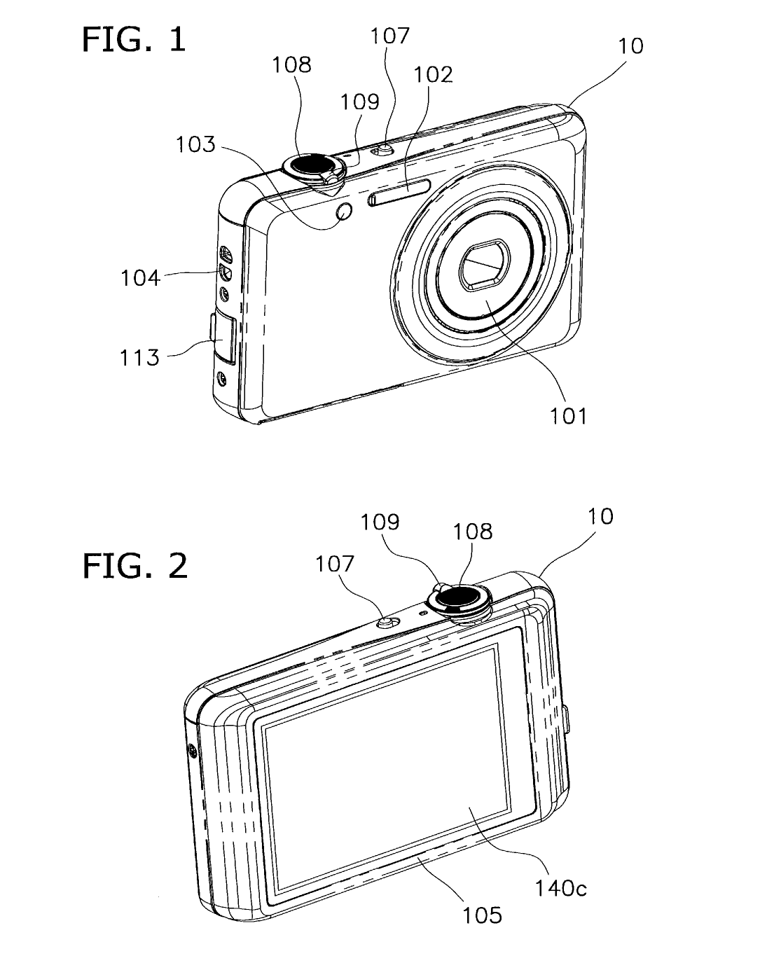

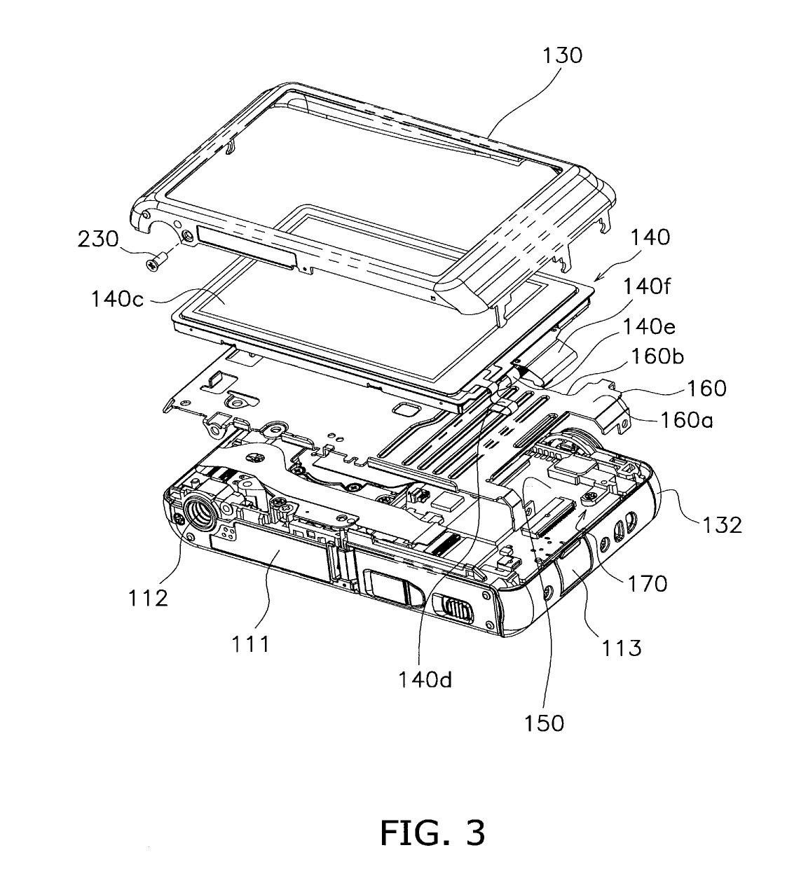

An embodiment of the present technology will now be described in detail as an example of the digital camera 10. FIG. 1 is an oblique view of the digital camera 10 pertaining to an embodiment of the present technology as seen from the front. FIG. 2 is an oblique view of the digital camera as seen from the rear. FIG. 3 is an exploded oblique view of the digital camera as seen from the rear.

Using as a reference a case in which the digital camera 10 is in its normal orientation, that is, its landscape orientation, the direction facing the subject will be referred to as “forward,” the direction going away from the subject as “rearward,” the vertical upward direction will be called “upward,” the vertical downward direction will be called “downward,” the right side (the right side in FIG. 1) when viewing the digital camera 10 from the subject will be called “to the right,” and the left side (the left side in FIG. 1) when viewing the digital camera 10 the subject will be called “to the left.”

A lens barrel 101 is provided to the front face of the digital camera 10. The lens barrel 101 guides subject light to an imaging element inside the digital camera 10. The lens barrel 101 includes a focus lens, a zoom lens, an aperture, and a plurality of other such optical members. The lens barrel 101 telescopes into the housing when the digital camera 10 is not in use, and extends out when the digital camera 10 is in use. Thus the digital camera 10 is smaller in size by mounting the lens barrel 101 so as to be movable in and out of the housing.

A flash 102 and an AF auxiliary lamp 103 are disposed on the front face of the digital camera 10. The flash 102 emits a flash during imaging in dark surroundings, which makes up for the lack of imaging light. The AF auxiliary lamp 103 emits auxiliary light so that autofocusing can be carried out more smoothly in dark surroundings.

A strap attachment hole 104 for attaching a strap is provided at the left end of the front face of the digital camera 10. With a compact electronic device intended to be carried around, such as the digital camera 10, there is the risk that the user will drop the digital camera 10. Attaching a strap to the strap attachment hole 104 prevents the digital camera 10 from being dropped.

A liquid crystal display unit 105 is provided to the rear face of the digital camera 10. The liquid crystal display unit 105 displays captured images, various operational screens, and so forth. A touch panel 140c is provided to the outer face of the liquid crystal display unit 105. The touch panel 140c receives touch commands. The operating mode of the digital camera 10 related to imaging, reproduction, and so on is switched, and the various settings of the digital camera 10 are changed, by operating the touch panel 140c on the basis of the information displayed on the touch panel 140c.

Since the touch panel 140c is operated by touch, the liquid crystal display unit 105 that includes the touch panel 140c needs to have a certain amount of strength. A sheet metal member 160 (support member; discussed below) is provided to meet this requirement. As discussed below, the sheet metal member 160 supports the liquid crystal display unit 105.

A sliding power switch 107 is provided to the top face of the digital camera 10. A shutter button 108 and a zoom ring 109 are also disposed on the top face of the digital camera 10. When the shutter button 108 is pressed, a still or moving picture is captured. The zoom ring 109 is disposed around the shutter button 108, so that it can rotate around the shutter button 108. Turning the zoom ring 109 changes the zoom ratio, and changes how far the lens barrel 101 extends out. When the zoom ratio is high, the lens barrel 101 extends out farther, and when the zoom ratio is low, the lens barrel 101 does not extend as far.

A terminal cover 113 is provided to the left side face of the digital camera 10. The terminal cover 113 is provided, for example, to the left side face of the digital camera 10 such that it can open and close toward the viewer of the drawing. A plurality of terminals for connecting the digital camera 10 to an external device are provided on the inside of the terminal cover 113.

These terminals include a USB (universal serial bus) terminal, an HDMI (high-definition multimedia interface) terminal, and so forth. For example, a USB terminal is used to connect the digital camera 10 to a personal computer, and captured images are transferred through this USB terminal to the personal computer. An HDMI terminal is used to connect the digital camera 10 to a television receiver, and captured images are displayed through this HDMI terminal on the television receiver.

As shown in FIG. 3, a battery cover 111 is provided to the bottom face of the digital camera 10. For example, the battery cover 111 is provided to the bottom face of the digital camera 10 such that it can open and close toward the viewer of the drawing. A battery and a memory card are housed on the inside of the battery cover 111. A tripod screw hole 112 for fixing the digital camera 10 to a tripod or the like is provided to the right end of the bottom face of the digital camera 10.

2. Unit Configuration

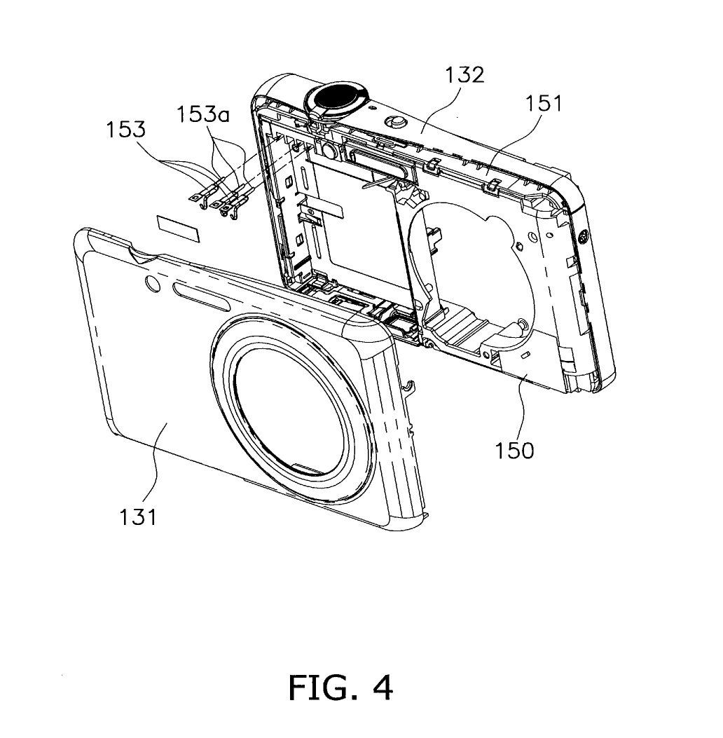

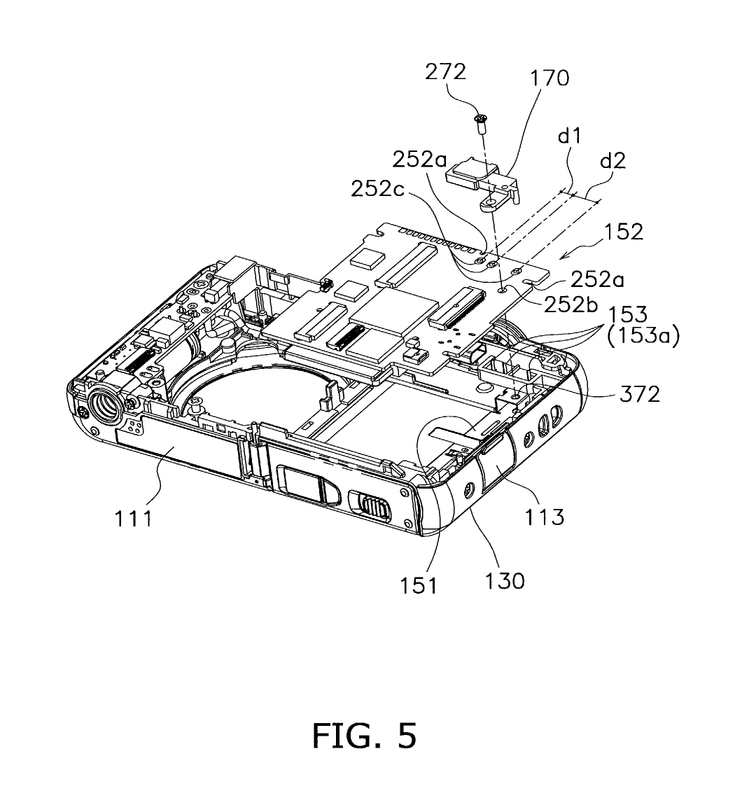

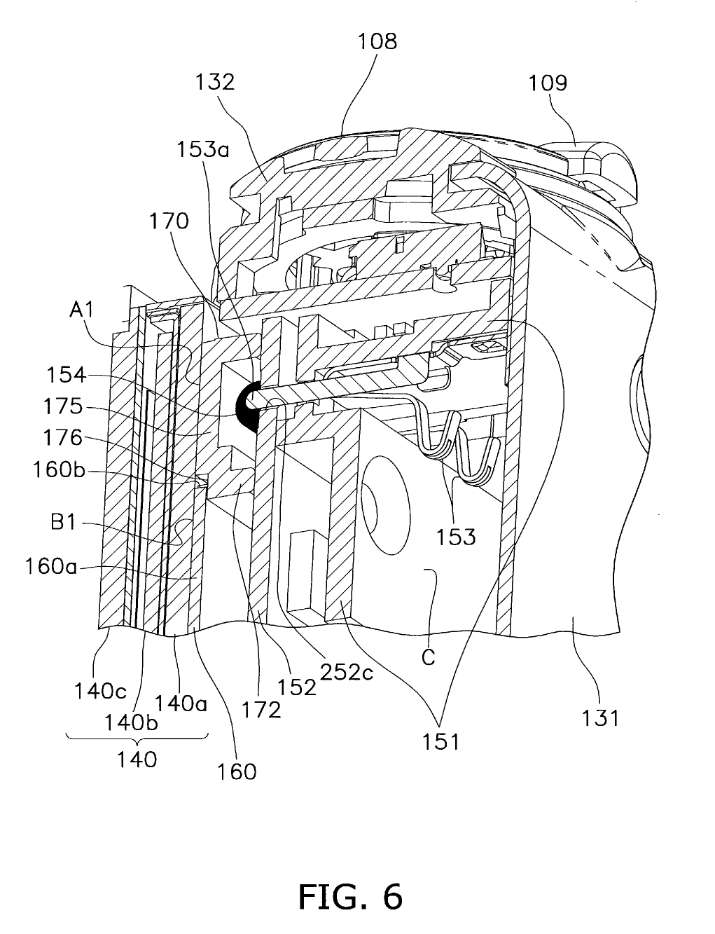

FIG. 4 is an exploded oblique view illustrating the mounting position of a battery terminal 153 in the digital camera 10. FIG. 5 is an exploded oblique view illustrating the mounting position of the cover member 170 in the digital camera 10. FIG. 6 is a partial cross section of the upper part of the digital camera 10.

As shown in FIGS. 3 to 6, the digital camera 10 mainly includes a rear housing 130, a front housing 131, an upper housing 132, the liquid crystal display panel unit 140 (display unit), and a main body unit 150. The rear housing 130, the front housing 131, and the upper housing 132 are each mounted to the main body unit 150. More precisely, the rear housing 130, the front housing 131, and the upper housing 132 are each mounted to a frame body 151 of the main body unit 150. The rear housing 130 and the front housing 131 are made from aluminum, stainless steel, or another such metal, for example. The upper housing 132 is made from plastic or the like, for example. The rear housing 130 and the front housing 131 may also be made from plastic or the like.

The liquid crystal display panel unit 140 is a unit that displays images. The liquid crystal display panel unit 140 is included in the liquid crystal display unit 105. As shown in FIG. 6, the liquid crystal display panel unit 140 has a backlight 140a, a liquid crystal display panel 140b, and the touch panel 140c. The backlight 140a, the liquid crystal display panel 140b, and the touch panel 140c are laminated and fixed in the liquid crystal display panel unit 140. The liquid crystal display panel unit 140 is mounted to the main body unit 150. More specifically, the liquid crystal display panel unit 140 is mounted to the sheet metal member 160 of the main body unit 150. The liquid crystal display panel unit 140 is positioned and supported by the sheet metal member 160.

The liquid crystal display panel unit 140 has various kinds of flexible cables. For example, the liquid crystal display panel unit 140 has a touch panel flexible cable 140d, a backlight flexible cable 140e, a liquid crystal display panel flexible cable 140f, and so forth. The various flexible cables are connected to connectors mounted on the main substrate unit 152 (discussed below).

Various kinds of circuit, such as a power circuit, a control circuit, and a signal processing circuit, are provided to the main body unit 150. The lens barrel 101, a battery and memory card (not shown), and so forth are housed in the main body unit 150. The above-mentioned rear housing 130, the front housing 131, the upper housing 132, and the liquid crystal display panel unit 140 are mounted to the main body unit 150.

3. Detailed Configuration of Main Body Unit

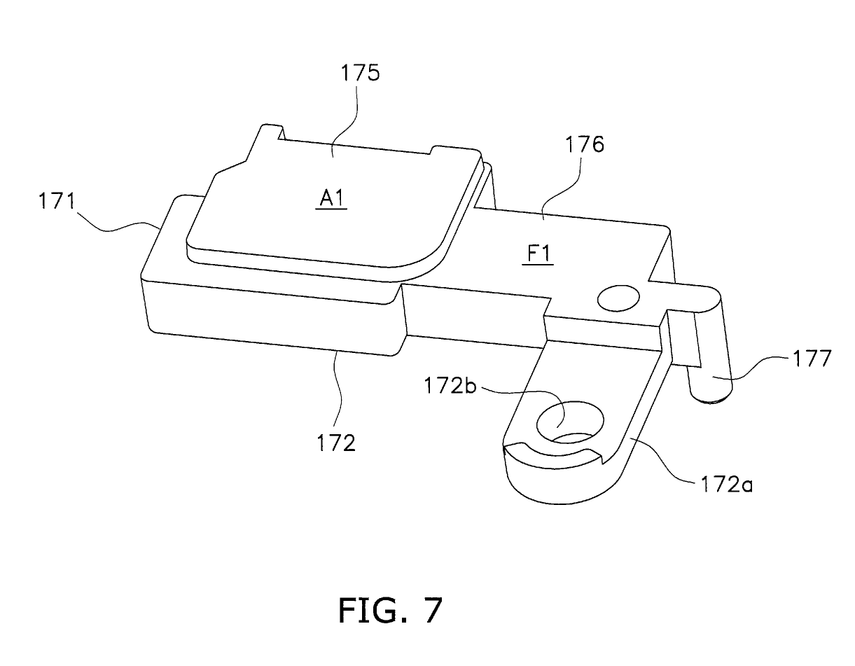

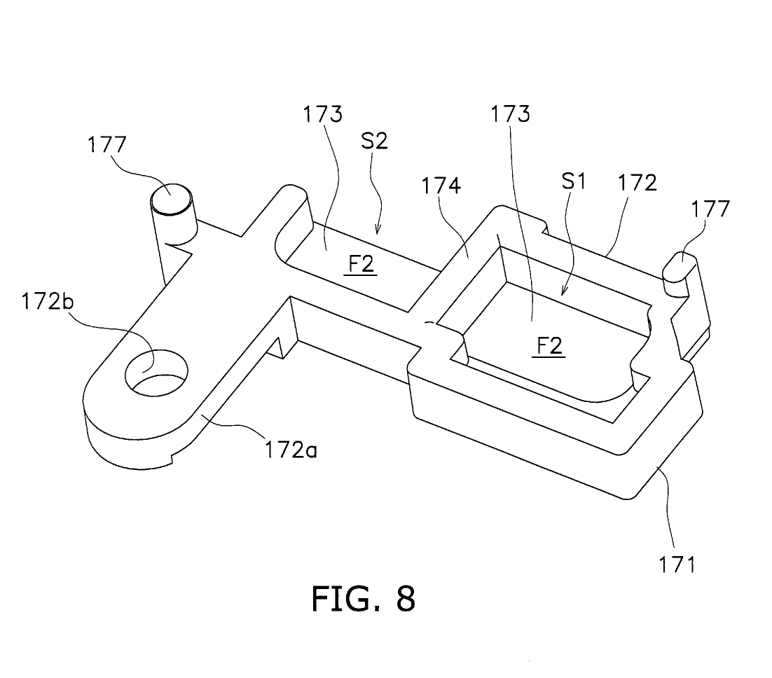

FIG. 7 is an oblique view of the cover member of the digital camera 10 as seen from above. FIG. 8 is an oblique view of the cover member of the digital camera 10 as seen from below.

As shown in FIGS. 3 to 6, the main body unit 150 mainly has the frame body 151, the main substrate unit 152, the sheet metal member 160, and the cover member 170.

3-1. Frame Body

The frame body 151 is a structure for mounting the various members. For example, the rear housing 130, the front housing 131, the upper housing 132, and so forth are mounted to the frame body 151. The main substrate unit 152, the sheet metal member 160, and so forth are also mounted to the frame body 151. Housing portions for housing the various members, various parts, and so forth are formed in the frame body 151. For example, a housing portion (not shown) for housing the lens barrel 101, a housing portion C (see FIG. 6) for housing the battery and memory card, and so forth are formed in the frame body 151.

3-2. Main Substrate Unit

A power circuit, a control circuit, and a signal processing circuit are disposed on the main substrate unit 152. The main substrate unit 152 is mounted to the frame body 151. The main substrate unit 152 is disposed opposite the liquid crystal display panel unit 140. As shown in FIG. 5, the main substrate unit 152 has two concave portions 252a for positioning the cover member 170, a hole 252b (the second hole discussed below) used for fixing the cover member 170, and three through-holes 252c used in forming a protrusion 154 (discussed below).

The protrusion 154 (an example of “a protruding portion”) is provided to the main substrate unit 152 as shown in FIG. 6. The face of the main substrate unit 152 on which the protrusion 154 is provided is disposed so as to be opposite the liquid crystal display panel unit 140. As shown in FIG. 4, the protrusion 154 is formed by the terminal 153 which is configured to connect to an electronic component. The terminal 153 shown in FIG. 4 is a terminal that comes into contact with a battery (a battery terminal). As shown in FIG. 6, this battery terminal 153 is mounted at one end to the frame body 151, and the other end is mounted to the main substrate unit 152, such as the through-holes 252c.

The protrusion 154 is a portion that is formed on the main substrate unit 152 by the distal end parts 153a of the battery terminal 153. More specifically, as shown in FIG. 5, the distal end parts 153a at the other end of the battery terminal 153 are inserted into the through-holes 252c of the main substrate unit 152. As shown in FIG. 6, the distal end parts 153a of the battery terminal 153 protruding from the through-holes 252c are welded to the main substrate unit 152, for example using solder. The portion formed by the distal end parts of the battery terminal 153 becomes the protrusions 154 (hereinafter referred to as protrusion terminals 154). The distal end parts 153a on the other end of the battery terminal 153 are inserted into the three through-holes 252c formed in the main substrate unit 152. Consequently, three protrusion terminals 154 are formed on the main substrate unit 152.

The three protrusion terminals 154 formed as above are disposed in a single row on the main substrate unit 152. In FIG. 5, they are disposed in order, starting from the left, as a positive electrode terminal 153, a temperature detector terminal 153, and a negative electrode terminal 153. The protrusions formed by these terminals form the three protrusion terminals 154 (a positive electrode protrusion terminal, a temperature detector protrusion terminal, and a negative electrode protrusion terminal). Also, as shown in FIG. 5, the positive electrode protrusion terminal 154 and the temperature detector protrusion terminal 154 are disposed spaced apart by a specific gap d1 (first gap), and the temperature detector protrusion terminal 154 and the negative electrode protrusion terminal 154 are disposed spaced apart by a specific gap d2 (second gap). Here, the three protrusion terminals 154 are disposed such that the second gap d2 is greater than the first gap d1.

3-3. Sheet Metal Member

The sheet metal member 160 is a member for supporting the liquid crystal display panel unit 140. The sheet metal member 160 is also a member for positioning the liquid crystal display panel unit 140. The sheet metal member 160 is mounted to the frame body 151. More specifically, as shown in FIG. 6, the sheet metal member 160 is disposed between the liquid crystal display panel unit 140 and the main substrate unit 152, and is fixed to the frame body 151 with screws 230 shown in FIG. 3. The liquid crystal display panel unit 140 is mounted to the sheet metal member 160.

The sheet metal member 160 has a sheet metal main body 160a and an avoidance portion 160b. The sheet metal main body 160a is formed in a substantially rectangular shape. The avoidance portion 160b is a portion for avoiding contact with the protrusion terminals 154. More specifically, the avoidance portion 160b is a portion that is cut out in a rectangular shape in the sheet metal main body 160a. At least part of the cover member 170 that covers the protrusion terminals 154 is disposed in this avoidance portion 160b.

3-4. Cover Member

As shown in FIG. 3 and FIGS. 5 to 8, the cover member 170 covers the protrusion terminals 154. The cover member 170 is disposed on the main substrate unit 152. For example, as shown in FIG. 3, the cover member 170 is disposed on the main substrate unit 152 in a state of covering the three protrusion terminals 154. More specifically, the cover member 170 is disposed on the main substrate unit 152 and fixed to the frame body 151. As shown in FIG. 6, the cover member 170 engages with the avoidance portion 160b of the sheet metal member 160 between the liquid crystal display panel unit 140 and the main substrate unit 152. The cover member 170 is configured to support the liquid crystal display panel unit 140. The cover member 170 is formed so as to support the area in the vicinity of the avoidance portion 160b. The cover member 170 having this configuration functions as an insulator. For example, the cover member 170 is an insulator made of plastic.

More specifically, as shown in FIGS. 7 and 8, the cover member 170 includes a main body 171, a substrate contact portion 172 (an example of a contact portion), a terminal cover 173, a separation portion 174, an opposing portion 175, a sheet metal support 176, and a fitting portion 177 (convex portion). The main body 171 is formed in the shape of a rectangular plate that extends in substantially one direction. The substrate contact portion 172 comes into contact with the main substrate unit 152. The substrate contact portion 172 protrudes outward from one face F2 of the main body 171, and is formed integrally with the main body 171. When this substrate contact portion 172 comes into contact with the main substrate unit 152, the cover member 170 is disposed over the main substrate unit 152 (see FIG. 6).

The substrate contact portion 172 has a substrate mounting portion 172a. The substrate mounting portion 172a is a portion that comes into contact with the main substrate unit 152, and is used to fix the cover member 170 to the frame body 151. The substrate mounting portion 172a has a first hole 172b. Here, as shown in FIG. 5, a male thread 272 is inserted into the first hole 172b and a second hole 252b provided to the main substrate unit 152. This male thread 272 is threaded into a female threaded hole 372 formed in the frame body 151. As a result, the cover member 170 is fixed to the frame body 151.

The terminal cover 173 covers the protrusion terminals 154. The terminal cover 173 is a portion that is formed in a concave shape. In FIG. 8, the terminal cover 173 is formed by the substrate contact portion 172 and one face F2 of the main body 171. The protrusion terminals 154 are housed by the terminal cover 173.

The separation portion 174 is a portion that spatially separates the positive electrode protrusion terminal 154 and the negative electrode protrusion terminal 154. The separation portion 174 protrudes outward from the face F2 of the main body 171, and is formed integrally with the main body 171. A first space S1 for housing the positive electrode protrusion terminal 154, and a second space S2 for housing the negative electrode protrusion terminal 154 are formed on the face F2 side of the main body 171. The first space S1 and the second space S2 is separated by the separation portion 174.

More specifically, the separation portion 174 is disposed between the temperature detecting protrusion terminal 154 and the negative electrode protrusion terminal 154, and this separation portion 174 comes into contact with the main substrate unit 152. In this state, the positive electrode protrusion terminal 154 and the temperature detecting protrusion terminal 154 are housed in the first space S1, and the negative electrode protrusion terminal 154 is housed in the second space S2. Thus, the separation portion 174 separates the positive electrode protrusion terminal 154 and the temperature detecting protrusion terminal 154 from the negative electrode protrusion terminal 154. This separation portion 174 prevents short circuiting between the positive electrode protrusion terminal 154 and the negative electrode protrusion terminal 154, for example, the short circuiting caused by the intrusion of foreign matter, etc.

The opposing portion 175 is a portion that is opposite the liquid crystal display panel unit 140. The opposing portion 175 is formed integrally with the face F1 of the main body 171. For example, the opposing portion 175 is formed protruding outward from the face F1 of the main body 171. As shown in FIG. 7, the top of the opposing portion 175 is formed in a planar shape. The opposing portion 175 is formed such that the face A1 at the top of the opposing portion 175 is in the same plane as the face B1 of the sheet metal member 160 that is opposite the liquid crystal display panel unit 140 (see FIG. 6), or is located slightly away from the face B1 of the sheet metal member 160 opposite the liquid crystal display panel unit 140, toward the main substrate unit 152 side. Also, as shown in FIG. 6, the opposing portion 175 engages with the avoidance portion 160b of the sheet metal member 160. More precisely, the opposing portion 175 engages with the avoidance portion 160b of the sheet metal member 160 so that the face A1 at the top is opposite the liquid crystal display panel unit 140.

The sheet metal support 176 supports the sheet metal member 160 in the vicinity of the avoidance portion 160b. The sheet metal support 176 is the face F1 of the main body 171, excluding the opposing portion 175. As shown in FIGS. 6 and 7, a predetermined step is formed between the face F1 of the sheet metal support 176 and the face A1 at the top of the opposing portion 175. For example, this step is slightly smaller than the thickness of the sheet metal member 160, or is the same as the thickness of the sheet metal member 160. More specifically, this step is slightly smaller than the thickness of the avoidance portion 160b of the sheet metal member 160, or is the same as the thickness of the avoidance portion 160b of the sheet metal member 160. In FIG. 6, an example is shown in which this step is the same as the thickness of the avoidance portion 160b of the sheet metal member 160.

The fitting portion 177 is used to position the cover member 170 on the main substrate unit 152. As shown in FIG. 8, the fitting portion 177 is formed integrally with the substrate contact portion 172. Here, for example, two fitting portions 177 are formed integrally with the substrate contact portion 172. The fitting portions 177 are each formed protruding outward from the substrate contact portion 172. The fitting portions 177 are fitted into the concave portions 252a (see FIG. 5) formed in the main substrate unit 152. As a result, the cover member 170 is positioned on the main substrate unit 152.

4. Assembly Related to Main Body Unit and Liquid Crystal Display Panel Unit

First, in a state in which the upper housing 132 has been mounted to the frame body 151, the three battery terminals 153 are mounted to the frame body 151 (see FIG. 4). In this state, the main substrate unit 152 is mounted to the frame body 151 (see FIG. 5). The distal end parts 153a of the three battery terminals 153 here are fixed by welding to the main substrate unit 152. As a result, the three protrusion terminals 154 (the positive electrode protrusion terminal, the temperature detecting protrusion terminal, and the negative electrode protrusion terminal) are formed on the main substrate unit 152.

Next, in a state in which the three protrusion terminals 154 have been formed on the main substrate unit 152, the fitting portions 177 of the cover member 170 are fitted into the concave portions 252a of the main substrate unit 152 (see FIG. 5). At the same time, the cover member 170 is disposed on the main substrate unit 152 (see FIG. 3) so that the positive electrode protrusion terminal 154 and the temperature detecting protrusion terminal 154 are housed in the first space S1, and the negative electrode protrusion terminal 154 is housed in the second space S2 (see FIG. 8).

Then, in a state in which the cover member 170 has been disposed on the main substrate unit 152 and the main substrate unit 152 has been disposed on the frame body 151 as discussed above, the male thread 272 is inserted into the first hole 172b of the cover member 170 and the second hole 252b provided to the main substrate unit 152, and threaded into the female threaded hole 372 of the frame body 151 (see FIGS. 3 and 5). As result, the cover member 170 is fixed to the frame body 151.

Then, the sheet metal member 160 is mounted to the frame body 151 so that the avoidance portion 160b of the sheet metal member 160 engages with the opposing portion 175 of the cover member 170 and comes into contact with the sheet metal support 176 of the cover member 170 (see FIG. 6). Here, the sheet metal member 160 is fixed to the frame body 151 with screws (not shown). Consequently, the face A1 of the opposing portion 175 and the face B1 of the sheet metal member 160 are disposed in the same plane.

Finally, the liquid crystal display panel unit 140 is mounted to the sheet metal member 160 so that one face of the sheet metal member 160 is opposite the opposing portion 175 of the cover member 170 (see FIGS. 3 and 6). The rear housing 130 is then mounted to the frame body 151 with screws 230 so as to cover the liquid crystal display panel unit 140.

5. Features

(A) The digital camera 10 mainly includes the liquid crystal display panel unit 140, the main substrate unit 152, the sheet metal member 160, and the cover member 170. The main substrate unit 152 is disposed opposite the liquid crystal display panel unit 140. The protrusion terminals 154, which protrude toward the liquid crystal display panel unit 140, are provided to the main substrate unit 152. The sheet metal member 160 supports the liquid crystal display panel unit 140 between the liquid crystal display panel unit 140 and the main substrate unit 152. The sheet metal member 160 has the avoidance portion 160b for avoiding contact with the protrusion terminals 154. The cover member 170 engages with the avoidance portion 160b between the liquid crystal display panel unit 140 and the main substrate unit 152, and covers the protrusion terminals 154.

Thus, with this digital camera 10, the cover member 170 covers the protrusion terminals 154 of the main substrate unit 152. Accordingly, even though the protrusion terminals 154 are formed on the main substrate unit 152, the protrusion terminals 154 on the main substrate unit 152 will not interfere with the sheet metal member 160 or the liquid crystal display panel unit 140. Also, the cover member is disposed on the main substrate unit 152 so as to engage with the avoidance portion 160b of the sheet metal member 160, so the digital camera 10 can be thinner. To summarize the above, with the digital camera 10, interference between parts is avoided and the device main body can be thinner.

(B) With the digital camera 10, the cover member 170 is able to support the liquid crystal display panel unit 140. More specifically, the cover member 170 engages with the avoidance portion 160b of the sheet metal member 160 so that the face A1 of the opposing portion 175 of the cover member 170 and the face B1 of the sheet metal member 160 opposite the liquid crystal display panel unit 140 are located in the same plane.

Consequently, even if the touch panel 140c, for example, of the liquid crystal display panel unit 140 should be pushed with a finger, a stylus pen, or some other such input means, the pressing force generated on the liquid crystal display panel unit 140 can be borne by the opposing portion 175 of the cover member 170 and the sheet metal member 160. That is, with this digital camera 10, interference between parts can be avoided and the device main body can be made thinner, without decreasing the stiffness of the liquid crystal display panel unit 140.

(C) With this digital camera 10, the cover member 170 is able to support the sheet metal member 160 in the vicinity of the avoidance portion 160b. More specifically, the sheet metal support 176 is formed on the cover member 170, and this sheet metal support 176 comes into contact with the avoidance portion 160b of the sheet metal member 160, and supports the sheet metal member 160 in the vicinity of the avoidance portion 160b.

Accordingly, even if the touch panel 140c, for example, of the liquid crystal display panel unit 140 should be pushed with an input means in the portion opposite the avoidance portion 160b of the sheet metal member 160 (the cut-out portion), the pressing force generated on the liquid crystal display panel unit 140 can be reliably borne by the opposing portion 175 of the cover member 170 and the sheet metal member 160. That is, with this digital camera 10, interference between parts can be avoided and the device main body can be made thinner, without decreasing the stiffness of the liquid crystal display panel unit 140.

(D) With this digital camera 10, the main substrate unit 152 has the concave portions 252a, and the cover member 170 has the fitting portions 177. Consequently, the cover member 170 can be easily positioned on the main substrate unit 152 by fitting the fitting portions 177 of the cover member 170 into the concave portions 252a of the main substrate unit 152.

(E) With this digital camera 10, the cover member 170 is able to electrically insulate the protrusion terminals 154 and the liquid crystal display panel unit 140. For example, the cover member 170 is an insulator made of plastic, and is disposed between the protrusion terminals 154 and the liquid crystal display panel unit 140. Consequently, electrical contact between the protrusion terminals 154 and the liquid crystal display panel unit 140 can be prevented by the cover member 170. Also, electrical contact between the protrusion terminals 154 and the sheet metal member 160 can be prevented by the cover member 170.

(F) With this digital camera 10, the battery terminals 153 are mounted on the main substrate unit 152, so that part of the battery terminals 153 protrudes toward the liquid crystal display panel unit 140 as the protrusion terminals 154. Accordingly, there is the risk of short circuiting if these protrusion terminals 154 should come into contact with the liquid crystal display panel unit 140, the sheet metal member 160, etc. However, with this digital camera 10, contact between the protrusion terminals 154 and the liquid crystal display panel unit 140 or the sheet metal member 160 is limited by the cover member 170, so the above-mentioned short circuiting can be effectively prevented.

(G) With this digital camera 10, the cover member 170 has the separation portion 174, which spatially separates the positive electrode protrusion terminal 154 and the negative electrode protrusion terminal 154. Consequently, short circuiting between the positive electrode protrusion terminal 154 and the negative electrode protrusion terminal 154 caused by the intrusion of foreign matter, etc., can be effectively prevented.

### Other Embodiments

An embodiment of the present technology was described above, but the present technology is not limited to the above embodiment, and various modifications are possible without departing from the gist of the technology. In particular, embodiments and modification examples given in this Specification can be combined as needed.

In the above embodiment, the cover member 170 was configured to support the vicinity of the avoidance portion 160b, but as long as the cover member 170 can cover the protrusion terminals 154, the configuration does not necessarily have to be one in which the vicinity of the avoidance portion 160b is supported.

In the above embodiment, an example was given in which the concave portions 252a were formed in the main substrate unit 152 in order to position the cover member 170, but the shape of the portion that positions the cover member 170 is not limited to that in the above embodiment, and any shape may be used. For instance, if holes are formed instead of the concave portions 252a in the main substrate unit 152, the cover member 170 may be positioned on the main substrate unit 152 by means of these holes. Also, just one of the two concave portions 252a may be changed to a hole.

In the above embodiment, an example was given in which the face A1 of the opposing portion 175 of the cover member 170 was located in the same plane as the face B1 of the sheet metal member 160 opposite the liquid crystal display panel unit 140, but the face A1 of the opposing portion 175 of the cover member 170 may be located more to the main substrate unit 152 side than the sheet metal member 160 opposite the liquid crystal display panel unit 140.

In the above embodiment, an example was given in which the liquid crystal display panel 140b was used, but an organic EL panel may be used instead of the liquid crystal display panel 140b. In this case, since the organic EL panel is a self-emitting display panel, there is no need for the backlight 140a. Also, even with a liquid crystal display panel, there will be no need for the backlight 140a if a reflective, rather than transmissive, type of liquid crystal display panel is employed.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the turns, “including”, “having” and their derivatives. Also, the terms “part,” “section,” “portion,” “member” or “element” when used in the singular can have the dual meaning of a single part or a plurality of parts. Accordingly, these terms, as utilized to describe the present technology should be interpreted relative to an electronic device.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present technology, it will be apparent to those skilled in the art from this disclosure that various changes and modifications can be made herein without departing from the scope of the technology as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further technologies by the applicant, including the structural and/or functional concepts embodied by such feature(s). Thus, the foregoing descriptions of the embodiments according to the present technology are provided for illustration only, and not for the purpose of limiting the technology as defined by the appended claims and their equivalents.

### INDUSTRIAL APPLICABILITY

The present technology can be widely applied to electronic devices.

What is claimed is:

1. An electronic device comprising:
a display unit;
a substrate unit disposed opposite the display unit and provided with at least one protruding portion that extends toward the display unit;
a support member disposed between the display unit and the substrate unit, the support member supports the display unit and includes an avoidance portion that avoids contact with the protruding portion; and
a cover member disposed between the display unit and the substrate unit, the cover member covers the protruding portion and configured to engage with the avoidance portion.

2. The electronic device according to claim 1, wherein
the cover member supports the display unit.

3. The electronic device according to claim 1, wherein
the cover member supports the area in the vicinity of the avoidance portion.

4. The electronic device according to claim 1, wherein
the cover member has a contact portion and an opposing portion integrally formed with the contact portion as a one-piece, unitary member, the contact portion is arranged to come into contact with the substrate unit, and the opposing portion is disposed opposite the display unit, and
the cover member is configured to engage the avoidance portion of the support member so that the face of the opposing portion is the same as the face of the support member opposite the display unit, or is located closer to the substrate unit than the face of the support member opposite the display unit.

5. The electronic device according to claim 1, wherein
the substrate unit defines a hole or a concave portion for positioning the cover member, and the cover member has a convex portion that mates with the hole or the concave portion.

6. The electronic device according to claim 1, wherein
the protruding portion and the display unit are electrically insulated by the cover member.

7. The electronic device according to claim 1 further comprising:
a terminal configured to engage an electronic component, wherein
when the terminal is mounted to the substrate unit, part of the terminal extends toward the display unit as the protruding portion.

8. The electronic device according to claim 7, wherein
the protruding portion includes at least one positive terminal and at least one negative terminal, and
the cover member has a separation portion that separates the positive terminals from the negative terminals.
